(19) United States
(12) Patent Application Publication
(10) Pub. No.: US 2026/0180887 A1
(43) Pub. Date: Jun. 25, 2026

(54) UTILIZING MEASUREMENT PROTOCOLS TO MONITOR BIT ERRORS

(71) Applicant: Cisco Technology, Inc., San Jose, CA (US)

(72) Inventor: Rakesh Gandhi, Stittsville (CA)

(21) Appl. No.: 19/090,164

(22) Filed: Mar. 25, 2025

Related U.S. Application Data
(60) Provisional application No. 63/738,214, filed on Dec. 23, 2024.

(51) Int. Cl. H04L 43/50; H04L 43/065; H04L 43/0823

(52) U.S. Cl. CPC H04L 43/50; H04L 43/065; H04L 43/0847

(57) ABSTRACT

Techniques for enhancing measurement protocols to monitor bit errors in network traffic. The techniques target a sender device and reflector device exchanging test packets to detect bit errors in forward and/or reverse paths using data encoded in extra padding TLVs of the test packets. The sender device may generate a test packet, add an extra padding TLV, and encode the extra padding TLV with data of a configurable size and/or pattern. The sender device may send the test packet to the reflector device, and the reflector device may analyze the data in the extra padding TLV to detect bit errors and potentially a count of bit errors detected. In some instances, the reflector device may reset the data in the extra padding TLV, add a padding bit error count TLV, and send a reply test packet back to the sender device to detect bit errors in the reverse path.

### RELATED APPLICATIONS

This application claims priority to Provisional Application No. 63/738,214, filed on Dec. 23, 2024, the entire contents of which are incorporated herein by reference.

### TECHNICAL FIELD

The present disclosure relates generally to enhancing measurement protocols to monitor bit errors in network traffic.

### BACKGROUND

Computer networks are collections of interconnected devices, such as computers, servers, and routers, that communicate with each other to share resources, exchange data, and provide services. These networks can be small, such as a local area network (LAN) connecting devices in a home or office, or a large Wide Area Network (WAN), such as the global Internet connecting billions of devices worldwide. To manage and troubleshoot these networks, measurement protocols have been introduced that allow network operators to collect and analyze data about network performance, traffic, and behavior. Measurement protocols are standardized sets of rules and procedures that enable devices to exchange data and metrics about the network, such as packet loss, latency, and throughput.

These measurement protocols are utilized to monitor network performance by measuring key metrics such as latency, bandwidth, packet loss, and jitter. Without these protocols, it would be difficult to diagnose issues, optimize resource allocation, or ensure quality of service (QoS) for critical applications. These protocols work by sending test packets or queries across the network and analyzing the responses. For example, the ping protocol measures round-trip time by sending Internet Control Message Protocol (ICMP) packets and waiting for replies, while Traceroute identifies the path that packets take through the network. More advanced protocols, such as Simple Network Management Protocol (SNMP) and Network Time Protocol (NTP), help in monitoring and synchronizing network operations.

Simple Two-Way Active Measurement Protocol (STAMP), which is defined in Internet Engineering Task Force (IETF) Request for Comments (RFC) 8762, is another type of measurement protocol that is used for measuring network performance between endpoints in a network. STAMP has become popular for use by network operators due to its ease in implementation, flexibility in supporting multiple protocols, scalability for large-scale networks, and accuracy due to the use of two-way measurements. STAMP was designed to measure performance metrics such as packet loss, delay, jitter, and throughput, but STAMP does not have the capability to measure other network performance metrics that network operators desire to monitor. Another similar standard that is popular is RFC 5357 for Two-way Active Measurement Protocol and RFC 4656 for One-Way Active Measurement Protocol also use extra padding data without the use of TLVs.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a system-architecture diagram of an environment in which a sender device and reflector device use a measurement protocol to detect bit errors in network traffic.

FIG. 2 illustrates an example of a test packet of a measurement protocol that is sent from a sender device to a reflector device to detect bit errors in a forward path using data encoded in an extra padding Type-Length-Value (TLV).

FIG. 3 illustrates an example of a reply test packet of a measurement protocol that is sent from a reflector device to a sender device that indicates bit errors detected in a test packet sent via a forward path, and is used to detect bit errors in a reverse path using data encoded in an extra padding TLV.

FIG. 4 illustrates an example of a test packet of a measurement protocol that is sent from a sender device to a reflector device to detect bit errors in a forward path using data encoded in an extra padding TLV and a checksum value.

FIG. 5 illustrates an example of a test packet of a measurement protocol that is sent from a sender device to a reflector device to detect bit errors in a forward path using data encoded in an extra padding TLV and one or more computed hash values.

FIG. 6 illustrates an example environment in which a sender device and reflector device use extra padding TLVs of test packets of a measurement protocol to detect bit errors in individual bundle member links of a link aggregation group.

FIG. 7 illustrates an example of a test packet of a measurement protocol in which session identifiers (IDs) are added to the test packet to ensure that reply test packets are sent over the same member link for the reverse path. 5v0ghsup

FIG. 8 illustrates a flow diagram of an example method for a sender device to send a test packet to a reflector device to detect bit errors in a forward path using data encoded in an extra padding TLV.

FIG. 9 illustrates a flow diagram of an example method for a reflector device to send a reply test packet to a sender device to indicate bit errors detected in a test packet sent via a forward path, and to detect bit errors in a reverse path using data encoded in an extra padding TLV.

FIG. 10 illustrates a block diagram illustrating an example packet switching system that can be utilized to implement various aspects of the technologies disclosed herein.

FIG. 11 illustrates a block diagram illustrating certain components of an example node that can be utilized to implement various aspects of the technologies disclosed herein.

FIG. 12 is a computer architecture diagram showing an illustrative computer hardware architecture for implementing a server device that can be utilized to implement aspects of the various technologies presented herein.

### DESCRIPTION OF EXAMPLE EMBODIMENTS

### Overview

The present disclosure relates generally to enhancing measurement protocols to monitor bit errors in network traffic. More specifically, the techniques target a sender device and reflector device exchanging test packets of a measurement protocol to detect bit errors in forward path and/or reverse paths using data encoded in extra padding TLVs of the test packets.

A first method to perform techniques described herein may be performed by a sender device and include configuring a measurement protocol session with a reflector device, where the measurement protocol session is usable to measure a network performance metric of a network link between the sender device and the reflector device. The first method may further include encoding, at the sender device, an extra padding Type-Length-Value (TLV) of a test packet with data, and sending the test packet from the sender device and to the reflector device. Additionally, the first method may include receiving, at the sender device, a reply test packet from the reflector device, and identifying, from the reply test packet, bit error data indicating whether the reflector device detected a bit error in the data encoded in the extra padding TLV of the test packet.

A second method to perform techniques described herein may be performed by a reflector device and include configuring a measurement protocol session with a sender device, where the measurement protocol session is usable to measure a network performance metric of a network link between the sender device and the reflector device. The second method may further include receiving a test packet that is sent from the sender device via the measurement protocol session, analyzing data encoded in an extra padding Type-Length-Value (TLV) of the test packet, and detecting, based on the analyzing, whether the data in the test packet indicates a bit error. Further, the second method may include generating bit error data that indicates whether a bit error was detected in the data, and sending a reply test packet to the sender device, the reply test packet including the bit error data.

Additionally, the techniques described herein may be performed by a system and/or device having non-transitory computer-readable media storing computer-executable instructions that, when executed by one or more processors, performs the method described above.

### EXAMPLE EMBODIMENTS

Measurement protocols are utilized to monitor network performance by measuring key metrics such as latency, bandwidth, packet loss, and jitter. Without these protocols, it would be difficult to diagnose issues, optimize resource allocation, or ensure QoS for critical applications. These protocols work by sending test packets or queries across the network and analyzing the responses. Various types of measurement protocols exist and have different advantages. STAMP (IETF standard defined in RFC 8762 and RFC 8972) is a measurement protocol that is used for measuring network performance between endpoints in a network. STAMP has become popular for use by network operators due to its ease in implementation, flexibility in supporting multiple protocols, scalability for large-scale networks, and accuracy due to the use of two-way measurements. STAMP was designed to measure performance metrics such as packet loss, delay, jitter, and throughput, but STAMP does not have the capability to measure other network performance metrics that network operators desire to monitor. Another similar standard that is popular is RFC 5357 for Two-way Active Measurement Protocol and RFC 4656 for One-Way Active Measurement Protocol also use extra padding data without the use of TLVs.

Specifically, STAMP is unable to detect bit errors (e.g., Cyclic Redundancy Check (CRC)) such as Ethernet Frame errors or fiber quality or satellite link checks. STAMP generally operates at Layer 3 (network layer), but bit errors are typically detected at lower layers, such as the Physical and Data Link layers (Layers 1 and 2), where error detection and correction mechanisms (e.g., CRC, Forward Error Correction, etc.) are implemented. STAMP measures whether a packet arrives or is lost, and calculates round-trip times (latency), but it does not inspect the contents of the packet for corruption. Rather, bit error detection has generally been handled by lower layers. However, there does not exist a single protocol that monitors not only monitor latency and loss measurement metrics, but also monitor bit errors. Further, networks often have a variety of devices that are of different types and manufactured by different vendors, and it is difficult to find measurement protocols that are interoperable among these various devices.

Networks may experience transmission bit errors due to various factors, such as poor fiber quality or poor satellite link. The bit error can be a single bit error or a burst of bit errors at a time. It is beneficial to detect bit errors and measure the bit error rate (BER) using active measurement packets between two nodes. For accurate bit error detection, transmitting large-sized active measurement packets is preferable, especially on links with low bit error rates. Furthermore, there is a need to transmit test packets at a high rate to detect bit errors on high-capacity links.

This disclosure describes techniques for enhancing measurement protocols, such as STAMP, to monitor bit errors in network traffic. More specifically, the techniques target a sender device and reflector device exchanging test packets of a measurement protocol to detect bit errors in forward path and/or reverse paths using data encoded in extra padding TLVs of the test packets. The sender device may generate a test packet and add an extra padding TLV (Type=1) as defined in RFC 8972, and may encode the extra padding TLV with data of a configurable size and/or pattern. The sender device may send the test packet to the reflector device, and the reflector device may analyze the data in the extra padding TLV to detect bit errors and potentially a count of bit errors detected. In some instances, the reflector device may reset the data in the extra padding TLV, add a padding bit error count TLV, and send a reply test packet back to the sender device to detect bit errors in the reverse path as well.

Initially, the sender device and reflector device (e.g., routers, switches, servers, user devices, etc.) may establish or configure a STAMP session for a physical link. For instance, the sender may create a session on a line card where a physical link is present, and generate a test packet to be sent to the reflector device. In addition to timestamping the test packet in hardware, the sender device may further add the STAMP extra padding TLV to the test packet. The sender device fills the extra padding TLV with data that is of a configurable size and pattern. Generally, it may be preferred to send test packets with larger payloads to detect bit errors as compared to smaller, frequent packets where bandwidth would be consumed by the headers (and headers are not used to detect bit errors). The test packets (or “probe packets”) padding size can be adjusted to the link maximum transmit unit (MTU) size (e.g., 9 kilobytes (KB)) as needed.

For accurate bit error detection, transmitting large-sized active measurement packets is preferable, especially on links with low bit error rates. Furthermore, there is a need to transmit test packets at a high rate to detect bit errors on high-capacity links.

In some instances, the sender device may fill or encoded the extra padding TLV with data that is of a predefined pattern (e.g., FFF000). The extra padding TLV may be of varying sizes (e.g., roughly 1400 bytes) in the forward direction, and sent at various rates (e.g., 1 Megabits rate). The sender device may further add a sending padding pattern TLV in which the sending padding pattern is indicated such that the reflector device is able to ascertain what the padding pattern of the data was when the data was transmitted. The sender device may then send or transmit the test packet to the reflector device over one or more networks and via the STAMP session.

The reflector device may receive the test packet and analyze the data encoded in the extra padding TLV with respect to the padding pattern indicated in the sender padding pattern TLV. The reflector device may determine a number of times, or a count, of bit errors by identifying changes in the pattern of the data encoded in the extra padding TLV as compared to the sender padding pattern. These bit errors may be due to various factors, such as poor fiber quality or poor satellite link, and may be a single bit error or a burst of bit errors at a time. The reflector device may determine a bit error count, and/or a bit error rate (BER) using these techniques.

The reflector device may then generate a reply test packet that includes a reflected extra padding TLV encoded with data having the predefined pattern. Further, the reply test packet may include a padding bit error count TLV in which the reflector device encodes the bit error count and/or the bit error rate of the test packet. The reflector device may then send this reply test packet back to the sender device. The sender device may use similar techniques to determine or calculate the bit error count and/or bit error rate of the reply test packet for the reverse path in addition to identifying the bit error count and/or bit error rate of the initial test packet sent in the forward path. The sender device may obtain any other measurement metrics (e.g., latency, packet drop rate, etc.) and report those metrics to a central management system and/or log the metrics locally. These metrics may be utilized for various reasons, such as identifying network congestion or faults, routing for QoS, networking troubleshooting, performance optimization, service level agreement (SLA) compliance, and so forth.

In some instances, rather than using a predefined pattern scheme to detect bit errors, the sender and reflector device may instead utilize a hashing scheme. In this example, the sender device and the reflector device may each receive a hash key (e.g., 128-bit hash key) that is used for hashing the data encoded in the extra padding TLV. The sender may use the hash key to compute a hash of the data in the extra padding TLV, and add the computed 128-bit hash in an extra padding hash TLV in the test packet in addition to the extra padding TLV. Hashing scheme may include HMAC, such as FEC/SHA-256 or truncated SHA-256 to 128-bit.

The reflector device may receive the test packet, compute the hash of the received data in the extra padding TLV, and compare the hash stored in the extra padding has TLV with the hash calculated by the reflector device. If the hashes match, the reflector device may determine that the data in the extra padding TLV did not include any bit errors. However, if the hashes do not match, the reflector device may determine that there is a bit error in the data encoded in the extra padding TLV. The reflector device may perform similar techniques (e.g., encode data, calculate a hash, etc.) for a reply test packet, populate the reply test packet with a result of the hash comparison (e.g., bit error detected, no bit error detected, etc.), and send the reply test packet back to the sender device.

In another example, the sender and reflector device may utilize a checksum scheme to detect bit errors in the test packets. In this example, the sender (and reflector for the return path) may calculate a 32-bit checksum of the entire packet including extra padding TLV (except transmit timestamp field). The checksum computed by the sender and reflector devices is added in a STAMP checksum TLV, and the reflector device sets a STAMP TLV flag to indicate if the checksum verification failed (e.g., checksums did not match indicating a bit error).

In some instances, the sender and reflector devices may establish bundle member links, or individual physical links that make up a logical bundle or Link Aggregation Group (LAG). These links operate together as a single logical interface to provide higher bandwidth, redundancy, and load balancing. STAMP generally measures performance at the link level, and thus, it is necessary to configure a separate STAMP session for each member link within a bundle. To establish a STAMP session for each member link, a unique Session ID is assigned to each link. The sender device creates sessions on the Line Cards (LCs) where the physical member links exist. The sender device then collects Layer 2 (L2) and Layer 3 (L3) header information of the parent bundle from an Adjacency Information Base (AIB) on the LCs, as AIB contains L2/L3 adjacency data for the bundle but not for individual member links. Next, the sender device pre-routes packets using the <L2><IP><UDP><STAMP> format over the member links. When pre-routed over the bundle interface, the Segment Packet Interface Output (SPIO) performs hashing and selects one of the member links. Further, the STAMP sender timestamps the packets in hardware, ensuring precise performance measurement.

Additionally, the sender device may add a TLV that carries a member link ID in the test packets such that the reflector device is able to send the reply test packet back over the same member link to measure the reverse path performance. Thus, the sender device and reflector device may send STAMP TLV (Type=11) with sender and reflector sides of 16-bit member IDs. In some instances, Sender Session ID is added as micro-session ID in the packet, but the reflector micro-session ID is not used (set to 0). The reflector device may use this TLV to pre-route the reply over the same member link, and the sender device uses this TLV to ensure that the packet is received from the expected member link. It should be noted that the reflector side of the micro-session ID can be configured under the member link on the sender to verify the received member link on the reflector side.

Although the techniques described herein are with respect to STAMP, the techniques are equally applicable to any measurement protocol that may be created or enhanced to measure bit error counts and/or bit error rates. Example protocols may include, but are not limited to, Two-Way Active Measurement Protocol (TWAMP), One-Way Active Measurement Protocol (OWAMP), IP Performance Metrics (IPPM), Bidirectional Forwarding Detection (BFD), Performance and Diagnostic Metrics (PDM), Precision Time Protocol (PTP)/Network Time Protocol (NTP), etc. Further, other mechanisms may be utilized in addition to, or as an alternative to, the pattern schemes, hashing schemes, and checksum schemes described herein.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

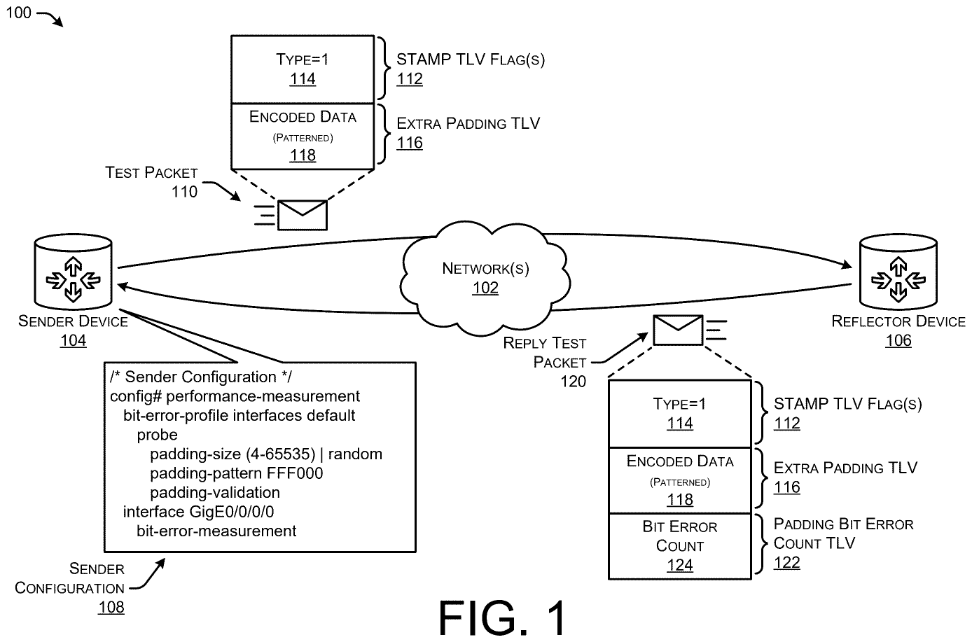

FIG. 1 illustrates a system-architecture diagram of an environment 100 in which a sender device 104 and reflector device 106 communicate network traffic over one or more networks 102 and use a measurement protocol to detect bit errors in the network traffic.

The sender device 104 and reflector device 106 may be any type of computing device capable of communicating over the network(s) 102, such as routers, switches, servers, user devices, networked appliances, edge computing devices, Internet of Things (IoT) devices, or any other type of computing devices.

Initially, the sender device 104 and reflector device 106 may establish or configure a STAMP session for a physical link. For instance, the sender device 104 may create a session on a line card where a physical link is present, and generate a test packet 110 to be sent to the reflector device 106. The sender device 104 may have a sender configuration 108 that configures the sender device 104 to generate the test packet 110 to use to measure but errors in the network traffic sent over the network(s) 102.

In addition to timestamping the test packet 110 in hardware, the sender device 104 may further add one or more STAMP TLV flags 112, including a Type=1 flag 114 as defined in RFC 8972 for STAMP packets, which indicates the extra padding TLV 116 for the test packet 110. The sender device 104 fills the extra padding TLV 116 with encoded data 118 that may be of a configurable size and pattern. Generally, it may be preferred to send test packets 110 with larger payloads to detect bit errors as compared to smaller, frequent packets where bandwidth would be consumed by the headers (and headers are not used to detect bit errors). The test packets 110 (or “probe packets”) padding size can be adjusted to the link MTU size (e.g., 9 KB) as needed.

In some instances, the sender device 104 may fill or encoded the extra padding TLV 116 with encoded data 118 that is of a predefined pattern (e.g., FFF000). The extra padding TLV may be of varying sizes (e.g., roughly 1400 bytes) in the forward direction, and sent at various rates (e.g., 1 Megabits rate). The sender device 104 may further add a sending padding pattern TLV in which the sending padding pattern is indicated such that the reflector device 106 is able to ascertain what the padding pattern of the data was when the data was transmitted. The sender device 104 may then send or transmit the test packet 110 to the reflector device 106 over the network(s) 102 and via the STAMP session.

The reflector device 106 may receive the test packet 110 and analyze the encoded data 118 in the extra padding TLV with respect to the padding pattern indicated in the sender padding pattern TLV. The reflector device 106 may determine a number of times, or a count, of bit errors by identifying changes in the pattern of the data encoded in the extra padding TLV as compared to the sender padding pattern. These bit errors may be due to various factors, such as poor fiber quality or satellite link, and may be a single bit error or a burst of bit errors at a time. The reflector device 106 may determine a bit error count, and/or a BER using these techniques.

The reflector device 106 may then generate a reply test packet 120 that includes a reflected extra padding TLV 116 encoded with the encoded data 118 having the predefined pattern (in instances where the pattern method is used). Further, the reply test packet 120 may include a padding bit error count TLV 122 in which the reflector device 106 encodes the bit error count 124 and/or the bit error rate of the test packet 110. The reflector device 106 may then send this reply test packet 120 back to the sender device 104. The sender device 104 may use similar techniques to determine or calculate the bit error count and/or bit error rate of the reply test packet 120 for the reverse path in addition to identifying the bit error count 124 and/or bit error rate of the initial test packet sent in the forward path. The sender device 104 may obtain any other measurement metrics (e.g., latency, packet drop rate, etc.) and report those metrics to a central management system and/or log the metrics locally. These metrics may be utilized for various reasons, such as identifying network congestion or faults, routing for QoS, networking troubleshooting, performance optimization, SLA compliance, and so forth.

In some instances, rather than using a predefined pattern scheme to detect bit errors, the sender device 104 and reflector device 106 may instead utilize a hashing scheme. In this example, the sender device 104 and the reflector device 106 may each receive a hash key (e.g., 128-bit hash key) that is used for hashing the data encoded in the extra padding TLV 116. The sender device 104 may use the hash key to compute a hash of the encoded data 118 in the extra padding TLV 116, and add the computed 128-bit hash in an extra padding hash TLV in the test packet 110 in addition to the extra padding TLV 116.

The reflector device 106 may receive the test packet 110, compute the hash of the received data in the extra padding TLV 116, and compare the hash stored in the extra padding has TLV with the hash calculated by the reflector device 106. If the hashes match, the reflector device 106 may determine that the data in the extra padding TLV 116 did not include any bit errors. However, if the hashes do not match, the reflector device 106 may determine that there is a bit error in the encoded data 118 in the extra padding TLV 116. The reflector device 106 may perform similar techniques (e.g., encode data, calculate a hash, etc.) for a reply test packet 120, populate the reply test packet 120 with a result of the hash comparison (e.g., bit error detected, no bit error detected, etc.), and send the reply test packet 120 back to the sender device 104.

In another example, the sender and reflector device 106 may utilize a checksum scheme to detect bit errors in the test packets 110. In this example, the sender (and reflector for the return path) may calculate a 32-bit checksum of the entire packet including extra padding TLV 116 (except transmit timestamp field). The checksum computed by the sender and reflector devices 106 is added in a STAMP checksum TLV, and the reflector device 106 sets a STAMP TLV flag to indicate if the checksum verification failed (e.g., checksums did not match indicating a bit error).

In some instances, the sender device 104 and reflector device 106 may establish bundle member links, or individual physical links that make up a logical bundle or Link Aggregation Group (LAG). These links operate together as a single logical interface to provide higher bandwidth, redundancy, and load balancing. STAMP generally measures performance at the link level, and thus, it is necessary to configure a separate STAMP session for each member link within a bundle. To establish a STAMP session for each member link, a unique Session ID is assigned to each link. The sender device 104 creates sessions on the Line Cards (LCs) where the physical member links exist. The sender device 104 then collects L2 and L3 header information of the parent bundle from an Adjacency Information Base (AIB) on the LCs, as AIB contains L2/L3 adjacency data for the bundle but not for individual member links. Next, the sender device 104 pre-routes packets using the <L2><IP><UDP><STAMP> format over the member links. When pre-routed over the bundle interface, the Segment Packet Interface Output (SPIO) performs hashing and selects one of the member links. Further, the STAMP sender timestamps the packets in hardware, ensuring precise performance measurement.

Additionally, the sender device 104 may add a TLV that carries a member link ID in the test packets 110 such that the reflector device 106 is able to send the reply test packet 120 back over the same member link to measure the reverse path performance. Thus, the sender device 104 and reflector device may send STAMP TLV (Type=11) with sender and reflector sides of 16-bit member IDs. In some instances, Sender Session ID is added as micro-session ID in the packet, but the reflector micro-session ID is not used (set to 0). The reflector device 106 may use this TLV to pre-route the reply over the same member link, and the sender device 104 uses this TLV to ensure that the packet is received from the expected member link. It should be noted that the reflector side of the micro-session ID can be configured under the member link on the sender to verify the received member link on the reflector side.

The network(s) 102 may include one or more networks implemented by any viable communication technology, such as wired and/or wireless modalities and/or technologies. The network(s) 102 may include any combination of Personal Area Networks (PANs), Local Area Networks (LANs), Campus Area Networks (CANs), Metropolitan Area Networks (MANs), extranets, intranets, the Internet, short-range wireless communication networks (e.g., ZigBee, Bluetooth, etc.) Wide Area Networks (WANs)—both centralized and/or distributed—and/or any combination, permutation, and/or aggregation thereof. The network(s) 102 may include devices, virtual resources, or other nodes that relay packets from one network segment to another by nodes in the computer network. The network(s) 102 may include multiple devices that utilize the network layer (and/or session layer, transport layer, etc.) in the OSI model for packet forwarding, and/or other layers.

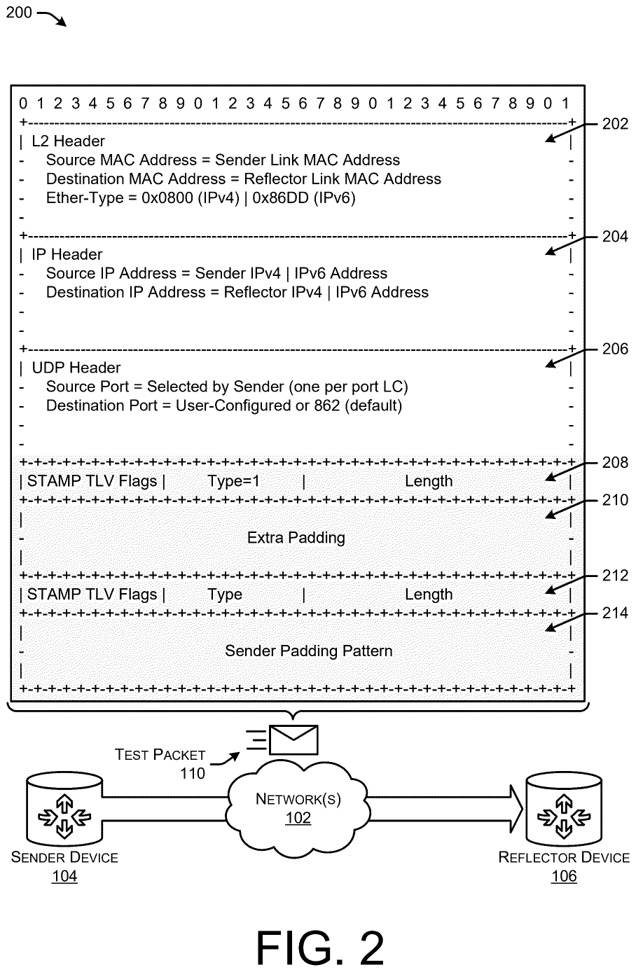

FIG. 2 illustrates a packet structure 200 of a test packet 110 of a measurement protocol that is sent from a sender device 104 to a reflector device 106 to detect bit errors in a forward path using data encoded in an extra padding TLV 116.

FIG. 2 illustrates a packet structure 200 for network communications between the sender device 104 and the reflector device 106 across the network(s) 102. The packet structure 200 may extend STAMP capabilities to include bit error detection. The packet structure may include multiple header sections arranged in a layered format. An L2 header section 202 may contain source MAC address information corresponding to a sender link MAC address and destination MAC address information corresponding to a reflector link MAC address. The L2 header section 202 may also include an Ether-Type field that can be set to 0x0800 for IPv4 or 0x86DD for IPv6.

Below the L2 header section 202, an IP header section 204 may contain source and destination IP address information for IPv4 or IPv6 addressing. A UDP header section 206 may follow, which may include source port information selected by the sender device 104 and destination port information that may be either user-configured or set to a default value of 862.

The packet structure 200 may contain multiple STAMP Type-Length-Value (TLV) sections. A STAMP TLV flags section 208 may be included that includes a Type=1 flag 114 as defined in RFC 8972 for STAMP packets, which indicates an extra padding TLV 210 for the test packet 110. In some cases, the sender device 104 may fill the extra padding TLV 210 with a predefined bit pattern. This predefined bit pattern may be used for detecting bit errors during transmission through the communication network 102.

A second STAMP TLV flags section 212, which have a type that has not been determined by a standard yet, may precede a sender padding section 214. In some cases, the sender padding section 214 may include an indication of a pattern according to which the encoded data 118 in the extra padding TLV 210 was encoded.

The test packet 110 having this packet structure may be transmitted between the sender device 104 and the reflector device 106 through the network(s) 102. The layered arrangement of headers and STAMP TLV sections may allow for the transmission and processing of network measurement data between the devices, while the inclusion of the extra padding TLV 210 and the TLVs may enable bit error detection capabilities.

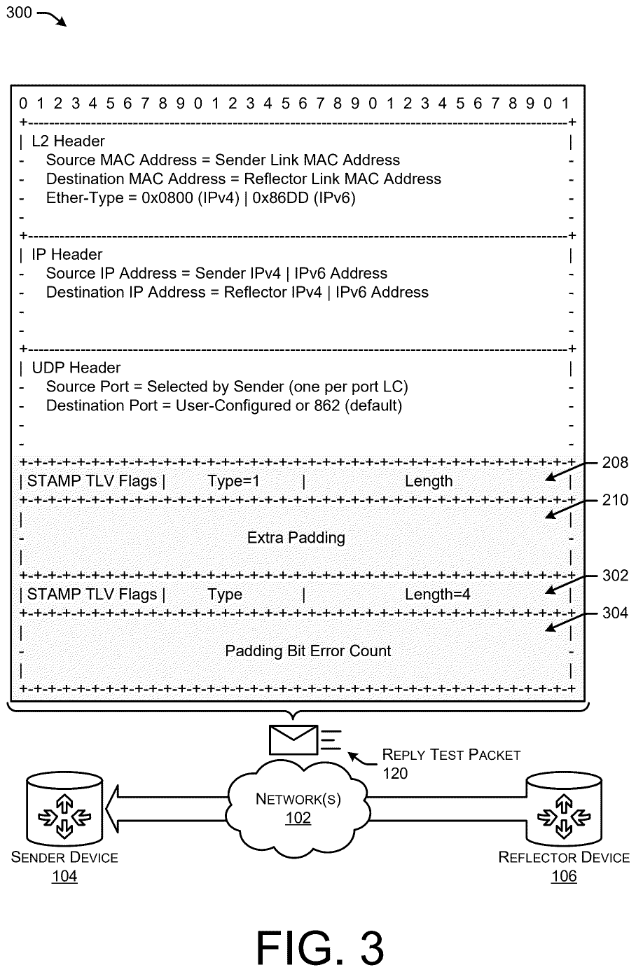

FIG. 3 illustrates packet structure 300 of a reply test packet of a measurement protocol that is sent from a reflector device 106 to a sender device 104 that indicates bit errors detected in a test packet 120 sent via a forward path, and is used to detect bit errors in a reverse path using data encoded in an extra padding TLV.

The packet structure 300 includes multiple header sections arranged in a hierarchical structure. At the top level, an L2 Header contains source and destination MAC addresses for communication between the sender device 104 and the reflector device 106, along with an Ether-Type field indicating IPv4 or IPv6 protocol. Below this, an IP Header section contains source and destination IP addresses for the sender device 104 and the reflector device 106.

The packet structure 300 includes a UDP Header section specifying source and destination ports, where the source port may be selected by the sender device 104 and the destination port may be either user-configured or set to a default value of 862.

The packet structure 300 may contain multiple STAMP TLV sections. A STAMP TLV flags section 208 may be included that includes a Type=1 flag 114 as defined in RFC 8972 for STAMP packets, which indicates an extra padding TLV 210 for the test packet 110. In some cases, the sender device 104 may fill the extra padding TLV 210 with a predefined bit pattern. This predefined bit pattern may be used for detecting bit errors during transmission through the communication network 102.

In some cases, a second STAMP TLV field 302, which may not have a specific type yet, may indicate that the following field includes a padding bit error count 304 for the test packet 110. For instance, the reflector device 106 may have determined a total bit error count detected in the encoded data 118 of the extra padding TLV of the test packet 110, and populate the padding bit error count 304 field with an indication of the determined total bit error count.

Thus, the reflector device 106 may check the extra padding TLV 116 for bit errors by comparing the received data against the predefined bit pattern. In some cases, the reflector device 106 may correct bit errors in the extra padding TLV 116 before reflecting the reply test packet 120 back to the sender device 104. This correction may allow for detection of bit errors in both forward and reverse directions of the communication network 102.

The hierarchical arrangement of headers and fields in the packet structure 300 may provide a structured way to encapsulate and transmit test data and bit error information between the sender device 104 and the reflector device 106. The inclusion of the padding bit error count TLV 122 in the reply test packet 120 may enable efficient reporting of detected bit errors, facilitating performance monitoring and troubleshooting in the environment 100.

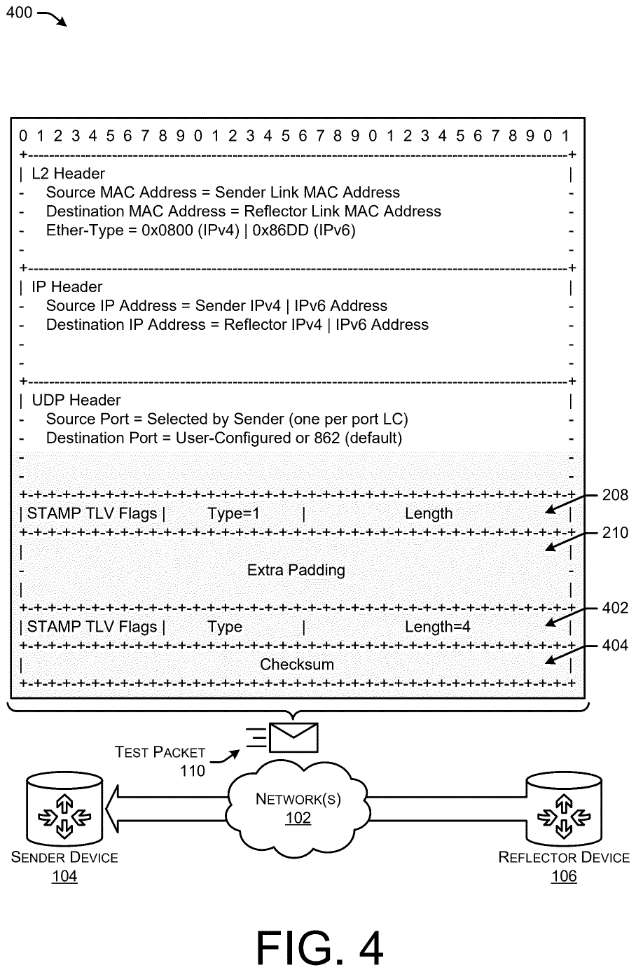

FIG. 4 illustrates a packet structure 400 of a test packet 110 of a measurement protocol that is sent from a sender device 104 to a reflector device 106 to detect bit errors in a forward path using data encoded in an extra padding TLV and a checksum value.

The packet structure 400 includes multiple header sections similar to those described in the packet structure 200 and packet structure 300. These sections may include the L2 header section, IP header section, and UDP header section for routing the test packet 110 between the sender device 104 and the reflector device 106.

In some cases, the packet structure 400 may contain the STAMP TLV flags section 208 and the extra padding TLV 210. The extra padding TLV 210 may include the encoded data 118 used for bit error detection.

A checksum stamp TLV flag 402 may be included after the extra padding TLV 210 in the network packet structure 400. The checksum stamp TLV flag 402 may be used to flag or indicate that a checksum field 404 is in the test packet 110.

Following the checksum stamp TLV flag 402, the packet structure 400 may include the checksum field 404. The checksum field 404 may contain checksum information for verifying the integrity of the test packet 110.

In some cases, the sender device 104 (and reflector device 106 for the return path) may calculate a 32-bit checksum of the entire packet including extra padding TLV (except transmit timestamp field). The checksum computed by the sender and reflector devices is added in a STAMP checksum TLV (e.g., checksum field 404), and the reflector device sets a STAMP TLV flag to indicate if the checksum verification failed (e.g., checksums did not match indicating a bit error).

By using a checksum-based approach, the packet structure 400 may enable more accurate detection of bit errors, including both single bit errors and burst errors. This checksum scheme may be particularly effective for detecting errors in large packets or on high-capacity links where traditional error detection methods may be less reliable.

The sender configuration 108 may include parameters for configuring the checksum scheme, such as the choice of checksum algorithm and the size of the checksum field 404. These configuration options may allow the network system to adapt the bit error detection process to different network conditions and requirements.

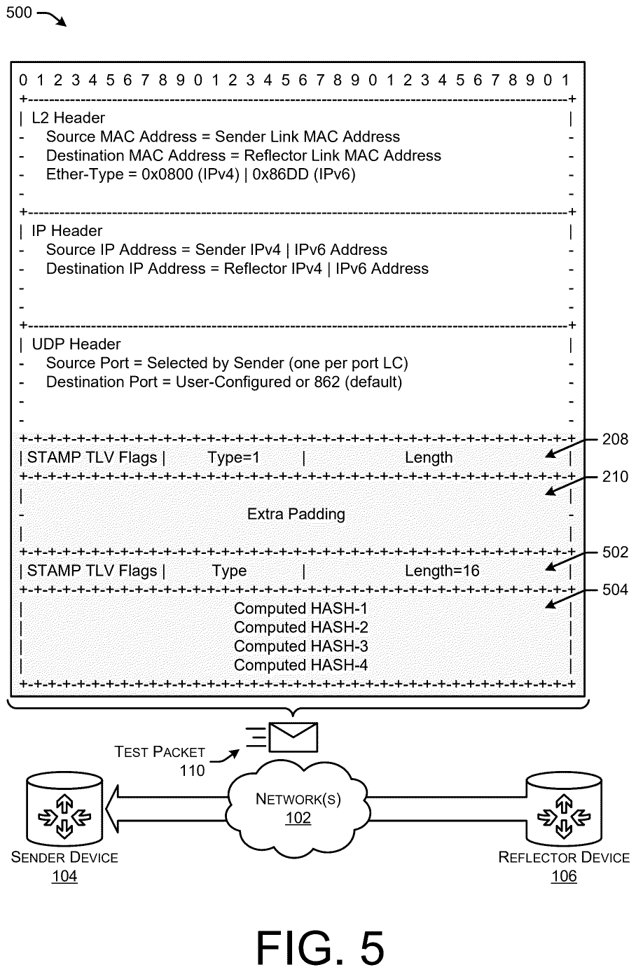

FIG. 5 illustrates an example of a packet structure 500 of a test packet 110 of a measurement protocol that is sent from a sender device 104 to a reflector device 106 to detect bit errors in a forward path using data encoded in an extra padding TLV and one or more computed hash values.

The test packet structure 500 includes multiple header sections arranged in a layered format. At the top level, the L2 header section contains source and destination MAC addresses for the sender and reflector link MAC addresses, along with an Ether-Type field indicating IPv4 or IPv6 protocol. Below this, the IP header section contains source and destination IP addresses for communication between the sender device 104 and the reflector device 106. The UDP header section follows, containing source and destination port information.

The test packet structure 500 includes the STAMP TLV flags section 208 and the extra padding TLV 210. Below these sections, the packet contains a hash STAMP TLV flag 502 with an extra padding hash TLV 504. The extra padding hash TLV 504 includes multiple computed hash values labeled as Computed HASH-1 through Computed HASH-4.

In some instances, rather than using a predefined pattern scheme to detect bit errors, the sender device 104 (and/or reflector device 106) may instead utilize a hashing scheme. In this example, the sender device 104 and reflector device 106 may each receive one or more hash keys (e.g., 128-bit hash keys) that are used for hashing the data encoded in the extra padding TLV 210. The sender device 104 may use the hash key to compute hash(es) of the data in the extra padding TLV 210, and add the computed 128-bit hash(es) in an extra padding hash TLV 504 in the test packet 110 in addition to the extra padding TLV 210.

The reflector device 106 may receive the test packet 110, compute the hash of the received data in the extra padding TLV 210, and compare the hash stored in the extra padding hash TLV 504 with the hash calculated by the reflector device 106. If the hashes match, the reflector device 106 may determine that the data in the extra padding TLV 210 did not include any bit errors. However, if the hashes do not match, the reflector device 106 may determine that there is a bit error in the data encoded in the extra padding TLV 210. The reflector device 106 may perform similar techniques (e.g., encode data, calculate a hash, etc.) for a reply test packet, populate the reply test packet with a result of the hash comparison (e.g., bit error detected, no bit error detected, etc.), and send the reply test packet back to the sender device.

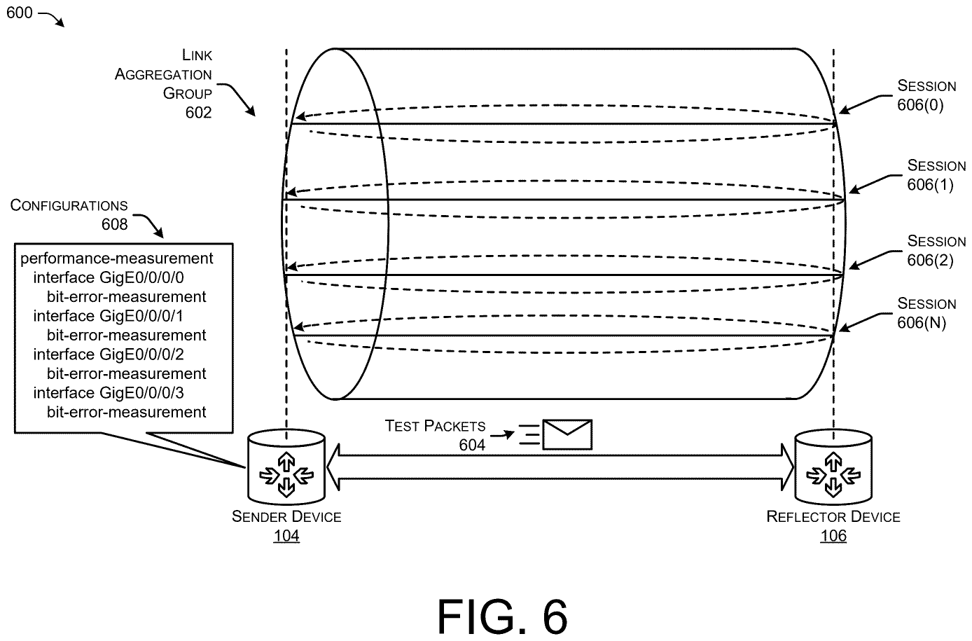

FIG. 6 illustrates a measurement system 600 in which a sender device 104 and reflector device 106 use extra padding TLVs of test packets 110 of a measurement protocol to detect bit errors in individual bundle member links of a link aggregation group 602.

The sender device 104 may perform bit error detection across bundle member links of the link aggregation group 602. The sender device 104 may be perform more granular performance monitoring for the bundled network connections across multiple sessions 606(0)-606(N) (where “N” could be any integer greater than 1).

Thus, the sender device 104 and reflector device 106 may establish include multiple concurrent measurement sessions 606. As shown in FIG. 6, these may include a first session 606(0), a second session 606(1), a third session 606(2), and an nth session 606(N). Each session 606 may operate independently to measure performance metrics across individual physical links within the link aggregation group 602.

The sender device 104 may include configurations 608 that specify performance parameters for bit-error-measurement interfaces. In some cases, the configurations 608 may define bit-error-measurement settings for multiple GigE interfaces (GigE0/0/0/0 through GigE0/0/0/3).

The test packets 604 transmitted between the sender device 104 and the reflector device 106 may contain measurement data used to detect bit errors and measure bit error rates across the bundle member link. The multiple concurrent sessions (606(0)-606(N)) may allow measurements to be taken simultaneously across different interfaces defined in the configurations 608.

In some cases, the sender device 104 may adjust the size of the test packets 604 up to the link Maximum Transmission Unit (MTU) size of 9 KB. This adjustment may allow for more accurate detection of bit errors, particularly on high-capacity links where smaller packets may not provide sufficient data for reliable error detection.

The sender device 104 may also adjust the rate of probe generation to detect bit errors more accurately during link bring-up. In some cases, this adjustment may involve increasing the frequency of test packet transmission during the initial stages of link establishment, allowing for quicker detection of any potential bit error issues.

The sender configuration 108 may include parameters for configuring these adjustments, such as maximum packet size and probe generation rate. These configuration options may allow the measurement system 600 to adapt the bit error detection process to different network conditions and requirements.

By enabling simultaneous measurements across multiple physical links within a bundle, the measurement system 600 may provide a more comprehensive view of network performance. This approach may allow network administrators to identify and isolate issues specific to individual member links, facilitating more targeted troubleshooting and optimization efforts.

To establish a session 606 for each member link, a unique Session ID is assigned to each link. The sender device 104 creates sessions on the Line Cards (LCs) where the physical member links exist. It then collects Layer 2 (L2) and Layer 3 (L3) header information of the parent bundle from the Adjacency Information Base (AIB) on the LCs, as AIB contains L2/L3 adjacency data for the bundle but not for individual member links. Next, the sender device 104 pre-routes packets using the <L2><IP><UDP><STAMP> format over the member links. When pre-routed over the bundle interface, the Segment Packet Interface Output (SPIO) performs hashing and selects one of the member links. Finally, the STAMP sender timestamps the packets in hardware, ensuring precise performance measurement.

The reflector device 106 then can use the unique session IDs to pre-route the reply test packets 120 back over the appropriate physical interfaces for the corresponding sessions 606 to measure reverse path performance.

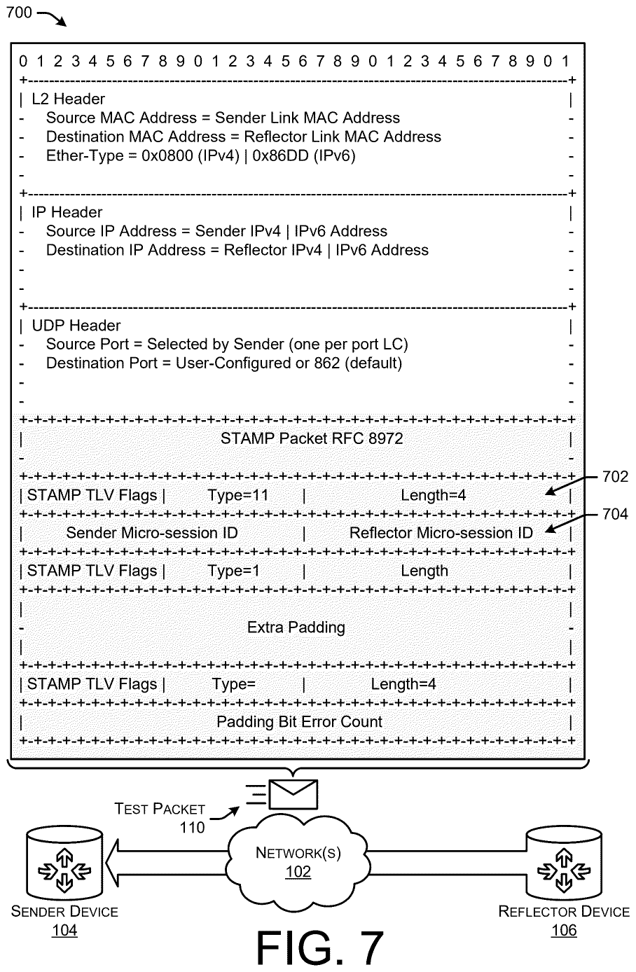

FIG. 7 illustrates an example of a packet structure 700 for a test packet 110 of a measurement protocol in which session IDs are added to the test packet 110 to ensure that reply test packets 120 are sent over the same member link for the reverse path.

The packet structure 700 includes multiple header sections arranged in a hierarchical format. At the top level, an L2 Header contains source and destination MAC address information, along with Ether-Type specifications for IPv4 or IPv6 protocols. Below this, an IP Header section carries source and destination IP address information for communication between the sender device 104 and the reflector device 106.

The packet structure 700 includes a UDP Header section that specifies source and destination port information, where the source port may be selected by the sender device 104 and the destination port may be user-configured or set to a default value of 862. The packet structure incorporates a STAMP Packet RFC 8972 section, followed by a member link ID TLV 702 (Type=11).

The member link ID TLV 702 may flag that there are micro-session ID TLVs 704 including a sender micro-session ID and/or a reflector micro-session ID. these micro-session TLVs 704 carry the member link IDs in the test packets 110 such that the reflector device 104 is able to send the reply test packet 120 back over the same member link to measure the reverse path performance. Thus, the sender device 104 and reflector device 104 may send STAMP TLV (Type=11) with sender and reflector sides of 16-bit member IDs. In some instances, Sender Session ID is added as micro-session ID in the packet, but the reflector micro-session ID is not used (set to 0). The reflector device 106 may use this TLV to pre-route the reply over the same member link, and the sender device 104 uses this TLV to ensure that the packet is received from the expected member link. It should be noted that the reflector side of the micro-session ID can be configured under the member link on the sender to verify the received member link on the reflector side.

By incorporating member link identification and supporting local configuration of bit patterns, the packet structure 700 may enable more precise and efficient performance measurements across bundled network connections. This capability may allow network administrators to identify and troubleshoot issues specific to individual member links within a bundle, improving overall network performance and reliability.

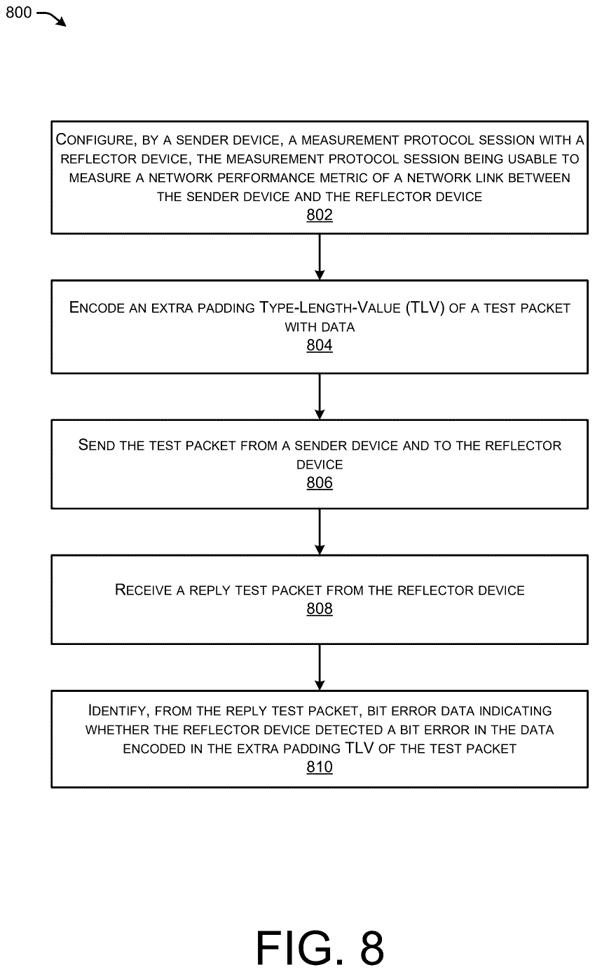

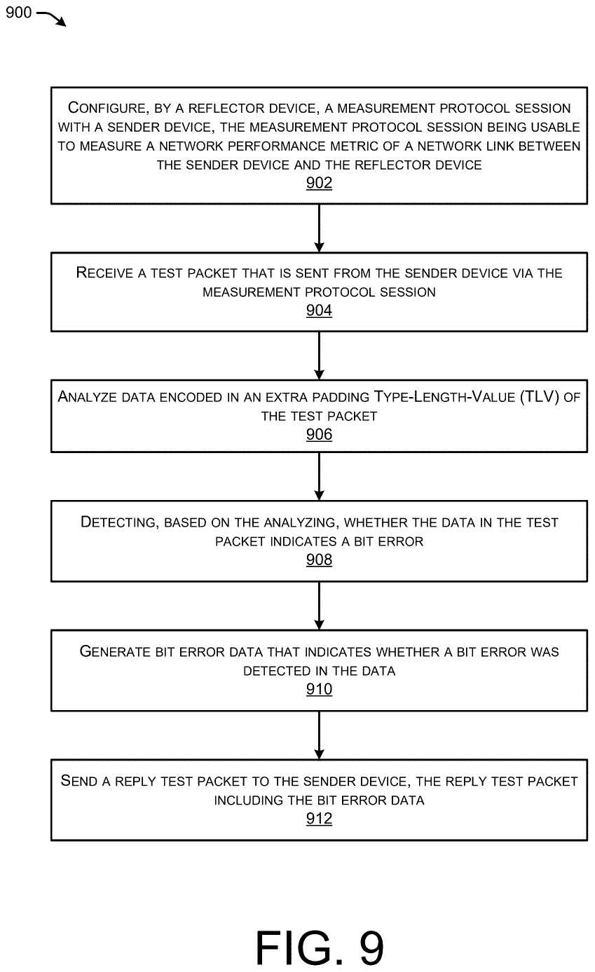

FIGS. 8 and 9 illustrate flow diagrams of example methods 800 and 900 that illustrate aspects of the functions performed at least partly by the devices described in FIGS. 8 and 9, such as the sender device 104, the reflector device 106, and so forth. The logical operations described herein with respect to FIGS. 8 and 9 may be implemented (1) as a sequence of computer-implemented acts or program modules running on a computing system and/or (2) as interconnected machine logic circuits or circuit modules within the computing system.

The implementation of the various components described herein is a matter of choice dependent on the performance and other requirements of the computing system. Accordingly, the logical operations described herein are referred to variously as operations, structural devices, acts, or modules. These operations, structural devices, acts, and modules can be implemented in software, in firmware, in special purpose digital logic, and any combination thereof. It should also be appreciated that more or fewer operations might be performed than shown in the FIGS. 8 and 9 and described herein. These operations can also be performed in parallel, or in a different order than those described herein. Some or all of these operations can also be performed by components other than those specifically identified. Although the techniques described in this disclosure is with reference to specific components, in other examples, the techniques may be implemented by less components, more components, different components, or any configuration of components.

FIG. 8 illustrates a flow diagram of an example method 800 for a sender device 104 to send a test packet 110 to a reflector device 106 to detect bit errors in a forward path using data encoded in an extra padding TLV.

At 802, the sender device 104 may configure a measurement protocol session with the reflector device 106. In some cases, this measurement protocol session may be a STAMP session usable to measure network performance metrics of a network link between the sender device 104 and the reflector device 106. The sender configuration 108 may define parameters for this measurement protocol session, such as performance measurement settings and probe configurations.

At a step 804, the sender device 104 may encode the extra padding TLV 116 of the test packet 110 with data. In some cases, this data may be the encoded data 118, which may include a predefined bit pattern used for detecting bit errors. The sender device 104 may fill the extra padding TLV 210 of the packet structure 200 with this predefined bit pattern.

At 806, the sender device 104 may send the test packet 110 to the reflector device 106 through the network(s) 102. The test packet 110 may include the L2 header section 202, the IP header section 204, the UDP header section 206, and the STAMP TLV flags section 208, in addition to the extra padding TLV 116 containing the encoded data 118.

At 808, the sender device 104 may receive the reply test packet 120 from the reflector device 106. The reply test packet 120 may have a packet structure 300 similar to the test packet 110, but may include additional information about detected bit errors.

At 810, the sender device 104 may identify, from the reply test packet 120, bit error data indicating whether the reflector device 106 detected a bit error in the data encoded in the extra padding TLV 116 of the test packet 110. In some cases, this bit error data may be contained in the padding bit error count TLV 122 of the reply test packet 120, with the bit error count 124 indicating the number of detected bit errors.

In some cases, the method 800 may utilize the packet structure 200, packet structure 400, or the packet structure 500 for enhanced bit error detection. The sender device 104 may compute a checksum or hash of the extra padding data and include this in the checksum field 404 or the extra padding hash TLV 504 of the test packet 110. The reflector device 106 may then use this information to perform more robust bit error detection.

The method 800 may be repeated for multiple measurement sessions, such as the first measurement session 606(0), the second measurement session 606(1), the third measurement session 606(2), and the fourth measurement session 606(3) in the measurement system 600. This may allow for simultaneous performance measurements across different member links of a bundled network connection. By using the extra padding TLV 116 for carrying predefined bit patterns and incorporating checksums or hashes, the method 800 may enable more accurate detection of bit errors in network communications. This enhanced STAMP implementation may provide network administrators with detailed insights into network performance, facilitating troubleshooting and optimization of network connections.

FIG. 9 illustrates a flow diagram of an example method 900 for a reflector device 106 to send a reply test packet 120 to a sender device 104 to indicate bit errors detected in a test packet 110 sent via a forward path, and to detect bit errors in a reverse path using data encoded in an extra padding TLV.

At 902, where the reflector device 106 may configure a measurement protocol session with the sender device 104. In some cases, this measurement protocol session may be a STAMP session usable to measure network performance metrics of a network link between the sender device 104 and the reflector device 106. The sender configuration 108 may define parameters for this measurement protocol session, such as performance measurement settings and probe configurations.

At 904, the method 900 involves the reflector device 106 receiving the test packet 110 sent from the sender device 104 via the measurement protocol session. The test packet 110 may include the L2 header section 202, the IP header section 204, the UDP header section 206, and the STAMP TLV flags section 208, in addition to the extra padding TLV 116 containing the encoded data 118.

At 906, the reflector device 106 may analyze the data encoded in the extra padding TLV 116 of the test packet 110. In some cases, this analysis may involve comparing the received data against a predefined bit pattern. The predefined bit pattern may be included in the test packet 110 or may be locally configured on the reflector device 106.

At 908, the reflector device 106 may detect, based on the analyzing, whether the data in the test packet 110 indicates a bit error. In some cases, this detection may involve identifying any discrepancies between the received data and the expected bit pattern. The reflector device 106 may count the number of bits that do not match the expected pattern.

At 910, the reflector device 106 may generate bit error data that indicates whether a bit error was detected in the data. In some cases, this bit error data may include the bit error count 124, which may represent the number of detected bit errors.

At 912, the reflector device 106 may send the reply test packet 120 to the sender device 104. The reply test packet 120 may include the bit error data generated in step 910. In some cases, this bit error data may be contained in the padding bit error count TLV 122 of the reply test packet 120.

In some cases, the method 900 may utilize the packet structure 200, packet structure 400, and/or the test packet structure 500 for enhanced bit error detection. The reflector device 106 may compute a checksum or hash of the received extra padding data and compare this with the value in the checksum field 404 or the extra padding hash TLV 504 of the received test packet 110. Any discrepancies may indicate the presence of bit errors.

The method 900 may be repeated for multiple measurement sessions, such as the first measurement session 606(0), the second measurement session 606(1), the third measurement session 606(2), and the fourth measurement session 606(3) in the measurement system 600. This may allow for simultaneous bit error detection across different member links of a bundled network connection.

By incorporating bit error detection and reporting capabilities, the method 900 may enhance the functionality of STAMP. This extended protocol may provide network administrators with more detailed insights into network performance, facilitating the identification and resolution of issues related to bit errors in network communications.

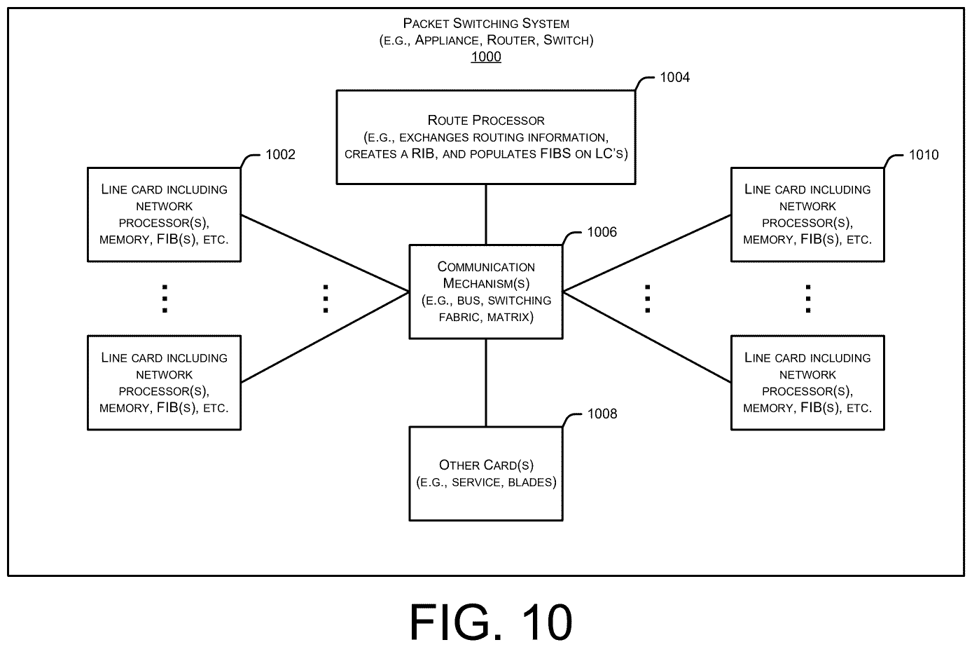

FIG. 10 illustrates a block diagram illustrating an example packet switching device (or system) 1000 that can be utilized to implement various aspects of the technologies disclosed herein. In some examples, packet switching device(s) 1000 may be employed in various networks or devices, such as, for example, the sender device 104 and/or reflector device 106 as described with respect to the previous figures.

The measure bit error rate metric computed may be used by IGP and BGP protocol to update the IGP (such as OSPF and ISIS) and TE metric of the link used for routing and traffic purpose by adding or removing penalty to the IGP and TE metrics.

The measurement may compute additional metrics of propagation latency (as minimum latency metric) on the wire using the timestamping packets in hardware and use that for routing and traffic engineering along with Bit error rate metric using the same measurement protocol used for BER

The measurement may also compute additional metric of packet loss using the same measurement protocol used for BER

The measurement may also detect the liveness and verify connectivity using the same measurement protocol used for BER. The liveness detection packets may employ loopback measurement.

The measurement may also service activation testing (SAT) using the same measurement protocol used for BER.

The Bit errors measurement can be used to compute statistics such as histogram distribution of bit errors, minimum and maximum bit errors during the day.

The metrics calculated for bit error count and bit error rate can be streamed via telemetry to network controller or other external devices for taking actions related to service level agreements and trouble-shooting the issues. Threshold based notifications can be used to detect the anomalies for generating operator alerts.

The procedure described are also equally applicable to measurement of any single-hop or multi-hop L3 IP or L2 path between Sender and Reflector nodes in the network.

In some examples, a packet switching device 1000 may comprise multiple line card(s) 1002, 1010, each with one or more network interfaces for sending and receiving packets over communications links (e.g., possibly part of a link aggregation group). The packet switching device 1000 may also have a control plane with one or more processing elements for managing the control plane and/or control plane processing of packets associated with forwarding of packets in a network. The packet switching device 1000 may also include other cards 1008 (e.g., service cards, blades) which include processing elements that are used to process (e.g., forward/send, drop, manipulate, change, modify, receive, create, duplicate, apply a service) packets associated with forwarding of packets in a network. The packet switching device 1000 may comprise hardware-based communication mechanism 1006 (e.g., bus, switching fabric, and/or matrix, etc.) for allowing its different entities 1002, 1004, 1008 and 1010 to communicate. Line card(s) 1002, 1010 may typically perform the actions of being both an ingress and/or an egress line card 1002, 1010, in regard to multiple other particular packets and/or packet streams being received by, or sent from, packet switching device 1000.

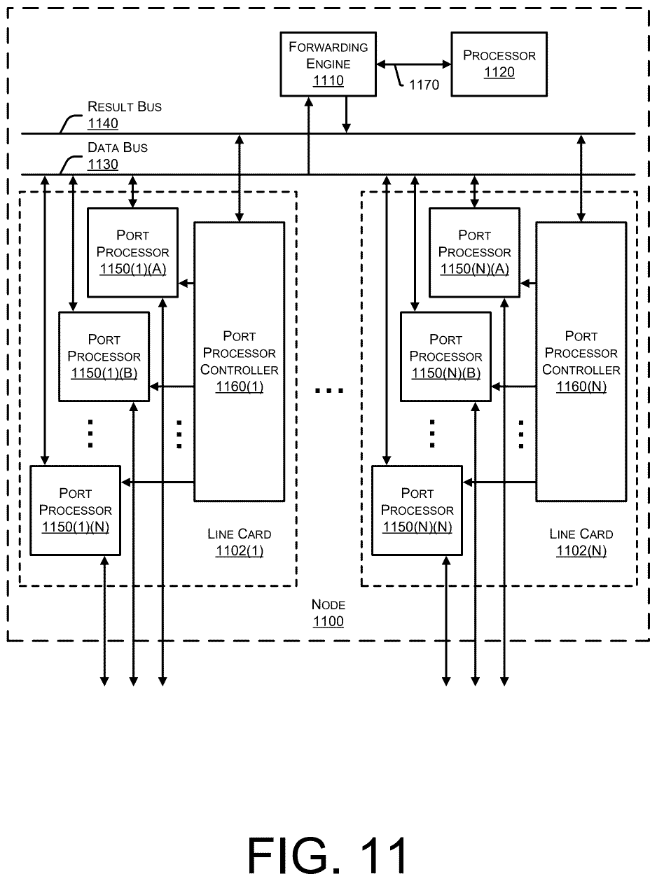

FIG. 11 illustrates a block diagram illustrating certain components of an example node 1100 that can be utilized to implement various aspects of the technologies disclosed herein. In some examples, node(s) 1100 may be employed in various networks or devices, such as, for example, the sender device 104 and/or reflector device 106 as described with respect to the previous figures.

In some examples, node 1100 may include any number of line cards 1102 (e.g., line cards 1102(1)-(N), where N may be any integer greater than 1) that are communicatively coupled to a forwarding engine 1110 (also referred to as a packet forwarder) and/or a processor 1120 via a data bus 1130 and/or a result bus 1140. Line cards 1102(1)-(N) may include any number of port processors 1180(1)(A)-(N)(N) which are controlled by port processor controllers 1160(1)-(N), where N may be any integer greater than 1. Additionally, or alternatively, forwarding engine 1110 and/or processor 1120 are not only coupled to one another via the data bus 1130 and the result bus 1140, but may also communicatively coupled to one another by a communications link.

The processors (e.g., the port processor(s) 1180 and/or the port processor controller(s) 1160) of each line card 1102 may be mounted on a single printed circuit board. When a packet or packet and header are received, the packet or packet and header may be identified and analyzed by node 1100 (also referred to herein as a router) in the following manner. Upon receipt, a packet (or some or all of its control information) or packet and header may be sent from one of port processor(s) 1180(1)(A)-(N)(N) at which the packet or packet and header was received and to one or more of those devices coupled to the data bus 1130 (e.g., others of the port processor(s) 1180(1)(A)-(N)(N), the forwarding engine 1110 and/or the processor 1120). Handling of the packet or packet and header may be determined, for example, by the forwarding engine 1110. For example, the forwarding engine 1110 may determine that the packet or packet and header should be forwarded to one or more of port processors 1180(1) (A)-(N)(N). This may be accomplished by indicating to corresponding one(s) of port processor controllers 1160(1)-(N) that the copy of the packet or packet and header held in the given one(s) of port processor(s) 1180(1)(A)-(N)(N) should be forwarded to the appropriate one of port processor(s) 1180(1)(A)-(N)(N). Additionally, or alternatively, once a packet or packet and header has been identified for processing, the forwarding engine 1110, the processor 1120, and/or the like may be used to process the packet or packet and header in some manner and/or maty add packet security information in order to secure the packet. On a node 1100 sourcing such a packet or packet and header, this processing may include, for example, encryption of some or all of the packets or packet and header's information, the addition of a digital signature, and/or some other information and/or processing capable of securing the packet or packet and header. On a node 1100 receiving such a processed packet or packet and header, the corresponding process may be performed to recover or validate the packets or packet and header's information that has been secured.

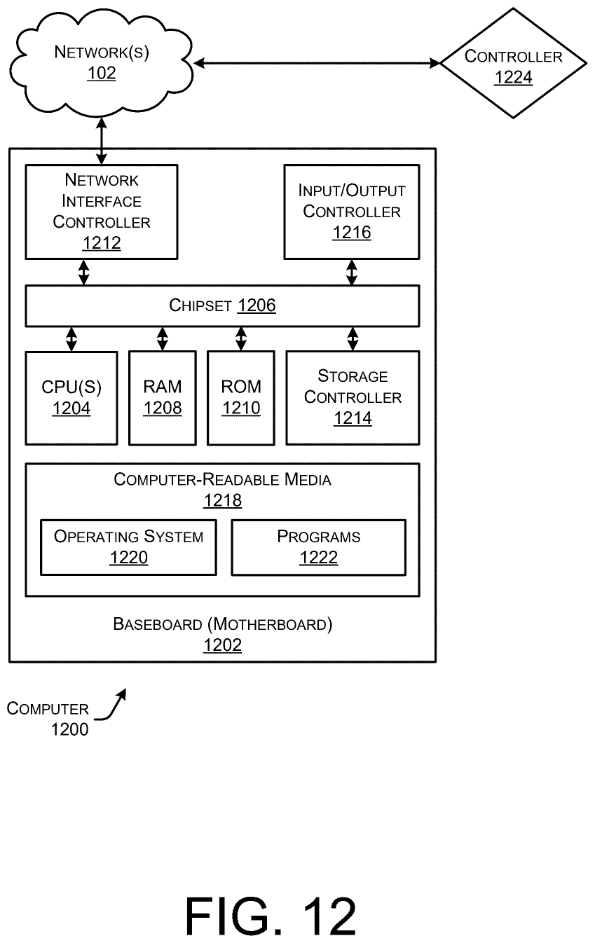

FIG. 12 shows an example computer architecture for a device capable of executing program components for implementing the functionality described above. The computer architecture shown in FIG. 12 illustrates any type of computer 1200, such as a conventional server computer, workstation, desktop computer, laptop, tablet, network appliance, e-reader, smartphone, or other computing device, and can be utilized to execute any of the software components presented herein. The computer may, in some examples, correspond to a sender device 104, a reflector device 106, and/or any other device described herein, and may comprise personal devices (e.g., smartphones, tables, wearable devices, laptop devices, etc.) networked devices such as servers, switches, routers, hubs, bridges, gateways, modems, repeaters, access points, and/or any other type of computing device that may be running any type of software and/or virtualization technology.

The computer 1200 includes a baseboard 1202, or “motherboard,” which is a printed circuit board to which a multitude of components or devices can be connected by way of a system bus or other electrical communication paths. In one illustrative configuration, one or more central processing units (“CPUs”) 1204 operate in conjunction with a chipset 1206. The CPUs 1204 can be standard programmable processors that perform arithmetic and logical operations necessary for the operation of the computer 1200.

The CPUs 1204 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 1206 provides an interface between the CPUs 1204 and the remainder of the components and devices on the baseboard 1202. The chipset 1206 can provide an interface to a RAM 1208, used as the main memory in the computer 1200. The chipset 1206 can further provide an interface to a computer-readable storage medium such as a read-only memory (“ROM”) 1210 or non-volatile RAM (“NVRAM”) for storing basic routines that help to startup the computer 1200 and to transfer information between the various components and devices. The ROM 1210 or NVRAM can also store other software components necessary for the operation of the computer 1200 in accordance with the configurations described herein.

The computer 1200 can operate in a networked environment using logical connections to remote computing devices and computer systems through a network, such as the network(s) 102. The chipset 1206 can include functionality for providing network connectivity through a NIC 1212, such as a gigabit Ethernet adapter. The NIC 1212 is capable of connecting the computer 1200 to other computing devices over the network(s) 102. It should be appreciated that multiple NICs 1212 can be present in the computer 1200, connecting the computer to other types of networks and remote computer systems.

The computer 1200 can be connected to a storage device 1218 that provides non-volatile storage for the computer. The storage device 1218 can store an operating system 1220, programs 1222, and data, which have been described in greater detail herein. The storage device 1218 can be connected to the computer 1200 through a storage controller 1214 connected to the chipset 1206. The storage device 1218 can consist of one or more physical storage units. The storage controller 1214 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 1200 can store data on the storage device 1218 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 1218 is characterized as primary or secondary storage, and the like.

For example, the computer 1200 can store information to the storage device 1218 by issuing instructions through the storage controller 1214 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 1200 can further read information from the storage device 1218 by detecting the physical states or characteristics of one or more particular locations within the physical storage units.

In addition to the mass storage device 1218 described above, the computer 1200 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 1200. In some examples, the operations performed by the sender device 104 and/or reflector device 106, and or any components included therein, may be supported by one or more devices similar to computer 1200. Stated otherwise, some or all of the operations performed by sender device 104 and/or reflector device 106, and or any components included therein, may be performed by one or more computer devices (e.g., computers 1200).

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 1218 can store an operating system 1220 utilized to control the operation of the computer 1200. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 1218 can store other system or application programs and data utilized by the computer 1200.

In one embodiment, the storage device 1218 or other computer-readable storage media is encoded with computer-executable instructions which, when loaded into the computer 1200, transform the computer from a general-purpose computing system into a special-purpose computer capable of implementing the embodiments described herein. These computer-executable instructions transform the computer 1200 by specifying how the CPUs 1204 transition between states, as described above. According to one embodiment, the computer 1200 has access to computer-readable storage media storing computer-executable instructions which, when executed by the computer 1200, perform the various processes described above with regard to FIGS. 1-11. The computer 1200 can also include computer-readable storage media having instructions stored thereupon for performing any of the other computer-implemented operations described herein.

The computer 1200 can also include one or more input/output controllers 1216 for receiving and processing input from a number of input devices, such as a keyboard, a mouse, a touchpad, a touch screen, an electronic stylus, or other type of input device. Similarly, an input/output controller 1216 can provide output to a display, such as a computer monitor, a flat-panel display, a digital projector, a printer, or other type of output device. It will be appreciated that the computer 1200 might not include all of the components shown in FIG. 8, can include other components that are not explicitly shown in FIG. 12, or might utilize an architecture completely different than that shown in FIG. 12.

As described herein, the computer 1200 may comprise one or more of a sender device 104, reflector device 106, and/or any other device. The computer 1200 may include one or more hardware processors (e.g., CPUs 1204) (processors) configured to execute one or more stored instructions. The CPUs 1204 may comprise one or more cores. Further, the computer 1200 may include one or more network interfaces configured to provide communications between the computer 1200 and other devices, such as the communications described herein as being performed by the sender device 104 and/or reflector device 106. The network interfaces may include devices configured to couple to personal area networks (PANs), wired and wireless local area networks (LANs), wired and wireless wide area networks (WANs), and so forth. For example, the network interfaces may include devices compatible with Ethernet, Wi-Fi™, and so forth.

The programs 1222 may comprise any type of programs or processes to perform the techniques described in this disclosure for selectively encrypting the unencrypted portions of packets for transmission through an encrypted tunnel where the packets are at least partially encrypted. For instance, the programs 1222 may cause the computer 1200 to perform techniques for communicating determining that portions of the packets are already encrypted, identifying portions of the packets that are unencrypted, and selectively encrypting the portions of the packets that are unencrypted prior to transmission through the encrypted tunnel. In this way, potentially private or sensitive data in the packets that is unencrypted, such as information in the packet headers, will be encrypted using the encryption protocol of the encrypted tunnel, but the data of the packets that is already encrypted, such as the payload, may avoid unnecessary double encryption. By reducing (or eliminating) the amount of data in data packets that is double encrypted, the amount of time taken by computing devices, and computing resources consumed, to encrypted traffic for encrypted tunnels may be reduced. Additionally, the programs 1222 may comprise instructions that cause the computer 1200 to perform the specific techniques for receiving packets through the encrypted tunnel and decrypting portions of the packets using different encryption protocols. The various information described herein (e.g., bit error rate, bit error count, etc.) may be reported to a controller 1224 for various networking operations.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method comprising:
configuring, by a sender device, a measurement protocol session with a reflector device, the measurement protocol session being usable to measure a network performance metric of a network link between the sender device and the reflector device;
encoding, at the sender device, an extra padding Type-Length-Value (TLV) of a test packet with data;
sending the test packet from the sender device and to the reflector device;
receiving, at the sender device, a reply test packet from the reflector device; and
identifying, from the reply test packet, bit error data indicating whether the reflector device detected a bit error in the data encoded in the extra padding TLV of the test packet.

2. The method of claim 1, wherein the data is encoded in the extra padding TLV according to a pattern, further comprising:
populating, at the sender device, a padding pattern check TLV with an indication of the pattern according to which the data is encoded,
wherein the indication of the pattern is usable by the reflector device to detect bit errors in the pattern of the data encoded in the extra padding TLV.

3. The method of claim 1, further comprising:
receiving, at the sender device, a hash key;
calculating, at the sender device, a hash of the data using the hash key; and
populating, at the sender device, an extra padding hash TLV of the test packet with the hash,
wherein the hash is usable by the reflector device to detect bit errors in the data encoded in the extra padding TLV.

4. The method of claim 1, further comprising:
calculating, at the sender device, a checksum of at least the data; and
populating, at the sender device, an extra padding hash TLV of the test packet with the hash,
wherein the hash is usable by the reflector device to detect bit errors in the data encoded in the extra padding TLV.

5. The method of claim 1, wherein the bit error data is associated with a forward direction of the network link, further comprising:
identifying, from the reply test packet, second data encoded in a second extra padding TLV of the reply test packet;
detecting a second bit error expressed in the second data; and
determining, based at least in part on the second bit error, a bit error rate associated with a return direction of the network link.

6. The method of claim 5, further comprising:
populating a session identifier (ID) TLV of the test packet with a session ID associated with the network link,
wherein the reflector device pre-routes the reply test packet over the network link based at least in part on the session ID being populated in the session ID TLV of the test packet.

7. The method of claim 1, wherein:
the measurement protocol session is configured according to a Simply Two-Way Active Measurement Protocol (STAMP) defined by Request for Comments (RFC) 8762; and
the extra padding TLV is defined by RFC 8972.

8. A sender device comprising:
one or more processors; and
one or more non-transitory computer-readable media storing computer-executable instructions that, when executed by the one or more processors, cause the one or more processors to perform operations comprising:
configuring a measurement protocol session with a reflector device, the measurement protocol session being usable to measure a network performance metric of a network link between the sender device and the reflector device;
encoding an extra padding Type-Length-Value (TLV) of a test packet with data;
sending the test packet to the reflector device;
receiving a reply test packet from the reflector device; and
identifying, from the reply test packet, bit error data indicating whether the reflector device detected a bit error in the data encoded in the extra padding TLV of the test packet.

9. The sender device of claim 8, wherein the data is encoded in the extra padding TLV according to a pattern, the operations further comprising:
populating a padding pattern check TLV with an indication of the pattern according to which the data is encoded,
wherein the indication of the pattern is usable by the reflector device to detect bit errors in the pattern of the data encoded in the extra padding TLV.

10. The sender device of claim 8, the operations further comprising:
receiving a hash key;
calculating a hash of the data using the hash key; and
populating an extra padding hash TLV of the test packet with the hash,
wherein the hash is usable by the reflector device to detect bit errors in the data encoded in the extra padding TLV.

11. The sender device of claim 8, the operations further comprising:
calculating a checksum of at least the data; and
populating an extra padding hash TLV of the test packet with the hash,
wherein the hash is usable by the reflector device to detect bit errors in the data encoded in the extra padding TLV.

12. The sender device of claim 8, wherein the bit error data is associated with a forward direction of the network link, the operations further comprising:
identifying, from the reply test packet, second data encoded in a second extra padding TLV of the reply test packet;
detecting a second bit error expressed in the second data; and
determining, based at least in part on the second bit error, a bit error rate associated with a return direction of the network link.

13. The sender device of claim 12, the operations further comprising:
populating a session identifier (ID) TLV of the test packet with a session ID associated with the network link,
wherein the reflector device pre-routes the reply test packet over the network link based at least in part on the session ID being populated in the session ID TLV of the test packet.

14. The sender device of claim 8, wherein:
the measurement protocol session is configured according to a Simply Two-Way Active Measurement Protocol (STAMP) defined by Request for Comments (RFC) 8762; and
the extra padding TLV is defined by RFC 8972.

15. A system comprising:
one or more processors; and
one or more non-transitory computer-readable media storing computer-executable instructions that, when executed by the one or more processors, cause the one or more processors to perform operations comprising:
configuring a measurement protocol session with a reflector device, the measurement protocol session being usable to measure a network performance metric of a network link between the system and the reflector device;
encoding an extra padding Type-Length-Value (TLV) of a test packet with data;
sending the test packet to the reflector device;
receiving a reply test packet from the reflector device; and
identifying, from the reply test packet, bit error data indicating whether the reflector device detected a bit error in the data encoded in the extra padding TLV of the test packet.

16. The system of claim 15, wherein the data is encoded in the extra padding TLV according to a pattern, the operations further comprising:
populating a padding pattern check TLV with an indication of the pattern according to which the data is encoded,
wherein the indication of the pattern is usable by the reflector device to detect bit errors in the pattern of the data encoded in the extra padding TLV.

17. The system of claim 15, the operations further comprising:
receiving a hash key;
calculating a hash of the data using the hash key; and
populating an extra padding hash TLV of the test packet with the hash,
wherein the hash is usable by the reflector device to detect bit errors in the data encoded in the extra padding TLV.

18. The system of claim 15, the operations further comprising:
calculating a checksum of at least the data; and
populating an extra padding hash TLV of the test packet with the hash,
wherein the hash is usable by the reflector device to detect bit errors in the data encoded in the extra padding TLV.

19. The system of claim 15, wherein the bit error data is associated with a forward direction of the network link, the operations further comprising:
identifying, from the reply test packet, second data encoded in a second extra padding TLV of the reply test packet;
detecting a second bit error expressed in the second data; and
determining, based at least in part on the second bit error, a bit error rate associated with a return direction of the network link.

20. The system of claim 19, the operations further comprising:
populating a session identifier (ID) TLV of the test packet with a session ID associated with the network link,
wherein the reflector device pre-routes the reply test packet over the network link based at least in part on the session ID being populated in the session ID TLV of the test packet.
